(19) United States
(12) Patent Application Publication
(10) Pub. No.: US 2002/0062527 A1
(43) Pub. Date: May 30, 2002

(54) Replaceable tool cartridges

(76) Inventor: Dan W. Harrison, Brownsboro, TX (US)

Correspondence Address: Charles W. Alworth, Alworth Law and Engineering, 505 (Formerly 502) Cumberland Road, Tyler, TX, 75703-9324, US

(21) Appl. No.: 09/726,767

(22) Filed: Nov. 29, 2000

Related U.S. Application Data
(60) Provisional application No. 60/167,862, filed on Nov. 29, 1999.

(51) Int. Cl. B25B 7/22

(52) U.S. Cl. 7/128

(57) ABSTRACT

A set of ancillary tools within a replaceable cartridge for use in multifunction hand tools. The ancillary tools would include knives, screwdrivers, can openers, and the like. The actual choice of tools would be set by the needs of the ultimate user and would allow the multifunction hand tool to be specifically tailored to the needs of the end user.

This application claims the benefit of priority of U.S. Provisional Application No. 60/167,862 filed on Nov. 29, 2000.

### TECHNICAL FIELD OF THE INVENTION

The instant invention relates to multiple function or combination tools and specifically relates to replaceable ancillary knife-like tools located within the handles of the base tool.

### BACKGROUND OF THE INVENTION

Multiple function or combination tools are well known in the art. The best-known tool is the so-called Swiss Army Knife that contains a variety of instruments, each having its own purpose. In the Swiss Army Knife the separate instruments are generally various forms of blade devices (knives, screwdrivers, scissors, saws, cork screws, and the like) that fold about a central axis in the case. In addition, there are some removable tools contained within the case such as a toothpick, a set of tweezers, or a small screwdriver held within a corkscrew.

One particular model of the Swiss Army Knife includes a set of folding pliers that uses the case as the first handle and a thin metal blade like device as the second handle. The pliers are somewhat difficult to use and the operator should hold the knife case (first) handle in the palm of the hand while pressing on the blade like second handle with the thumb of the same hand. It is a difficult tool to use and one cannot exert a great amount of pressure on an object being gripped by the pliers.

### PRIOR ART

Leatherman (U.S. Pat. Nos. 4,238,862 and 4,744,272) and Collins (U.S. Pat. No. 5,062,173) disclosed a folding combination tool based around a set of pliers that are manipulated in the standard fashion by gripping the opposing handles between the heel of the thumb and the fingers of the hand. The handles of these devices contain blade-like tools such as knives, various screwdrivers, scissors, saws, cork screws, and the like. In the case of the Leatherman disclosures, the blade-like tools fold outward from the reverse end of the handles of the associated set of pliers. The greatest drawback of the Leatherman tool is that the hand closes around the open “U” of the handles; thus, when one exerts a large force the open “U” tends to cut into the skin. Collins improved the Leatherman Tool by rotating the “U” by ninety-degrees; thus, one grips a flat surface (namely the outside of one of the sidewalls of the “U”) when squeezing on the handles of the pliers.

Harrison in 1989 invented an improvement to the Leatherman/Collins tools in which the pliers retract into U-shaped handles when they are out of service and which was confidentially disclosed to an author for the trade paper Knife World in November 1989. (Knife World, November 1993, Volume 19, Number 11.) The original Harrison tool (hereafter the “1989 Harrison Tool”) essentially turned the “U” handles upside down, so that when the hand gripped the handles, no sharp edges were exposed to the user. I.e., the user gripped the outside wall of the channel section of the U-shaped handles. The pliers were locked in the retracted position or in the extended position by a simple spring loaded pin lock that moved from one position to another in the channel portion of each of the handles. Like the Leatherman device, each handle further contained a series of knife-like ancillary tools that rotated out from the handles opposite the pliers.

Sessions et al. (U.S. Pat. No. 5,142,721, filed on Mar. 8, 1991 and U.S. Pat. No. 5,212,844, filed on Jul. 28, 1992) disclose a device strikingly similar to the 1989 Harrison Tool. The Sessions tool uses two “U” shaped handles with the set of pliers being slidingly and retractably contained within the “U” handles. The pliers are locked in the open position or the closed position by a tang operating within a slot in the channel section of the “U” shaped handle in a manner similar the 1989 Harrison Tool. The user's hand gripped the handles of the pliers in such a manner that the fingers and heel of the thumb exerted the operating force against the outside of the channel section of the “U” shaped handles exactly like the 1989 Harrison Tool. Like the Leatherman, Collins, and 1989 Harrison devices, each ‘Sessions’ handle contained a series of knife-like ancillary tools that rotated out from the handles opposite from the pliers.

Other “me-too” multifunction or combination tools have been produced by numerous manufacturers and sold throughout the world. These tools are similar to the aforementioned tools and include knife-like ancillary tools in the base tool handle.

As stated above, all of the above tools included ancillary tools within the ends of the handles opposite the jaws. These tools included knives, screwdrivers (Flat and Philips), can and bottle openers, saws, scissors, and the like. Until recently, the ancillary tools were/are permanently fixed within the base tool. Nabors et al. (U.S. Pat. No. 5,960,498) disclosed a Foldable Tool with Removable Tool Cartridges. Nabors produced a tool in which the ancillary tools were encased in removable cartridge. The cartridge fitted into a slot at the end of the handles, slipped into and rotated about the slot and was retained in the handle by a catch within the cartridge located at the jaws end of the base tool.

The Nabors cartridge is unique to the Nabors' basic tool and will not readily adapt to other tools currently on the market. Thus there remains a need for an ancillary replaceable tool cartridge for use in multifunction or combination tools, which are currently on the market. Further there remains a need for varying types of replaceable ancillary tool cartridges, which can meet the express needs of the base tool user. For example, a set of ancillary tools for the angular, a set for the electrician, the electronics technician, the computer repairman, the archer, etc. is needed.

### SUMMARY OF THE INVENTION

The present invention utilizes a “U-shaped” cartridge which pivotally holds the ancillary knife-like tool(s) and provide the usual “spring loading” when the tool is rotated out of the cartridge. The pivot point about which the tools rotate is hollow and capable of accepting a bolt or a clip that passes axially through the pivot. The base tool is not manufactured with ancillary tools in place, but rather it is manufactured with two apertures which would be capable of accepting the standard ancillary tool pivot initially originally used in the base tool. One of the two apertures is threaded and the other is unthreaded.

The ancillary tool cartridge is placed within the handle and a bolt passed through the unthreaded aperture in the handle, through the hollow pivot point of the cartridge, and threaded into the threaded aperture in the handle. Thus the cartridge is solidly held in place within the handle(s). The ancillary tools are used in the standard manner and the choice of the combination of the knife-like ancillary tools would be up to the user of the base tool.

The cartridge can be manufactured to retrofit any and all base tools currently on sale which use pivotally attached ancillary tools within the base tool handle(s). New base tools would be manufactured to accept the cartridge. Old tools would have the ancillary tool pivot carefully drilled out, one remaining aperture threaded while the other is slightly enlarged to accept the retaining bolt; thus, allowing the cartridge to be retrofitted to older base tools.

### BRIEF DESCRIPTION OF THE DRAWINGS

Figure One is an end on illustration of the instant device without the knife-like tools in place nor the spring loading tangs.

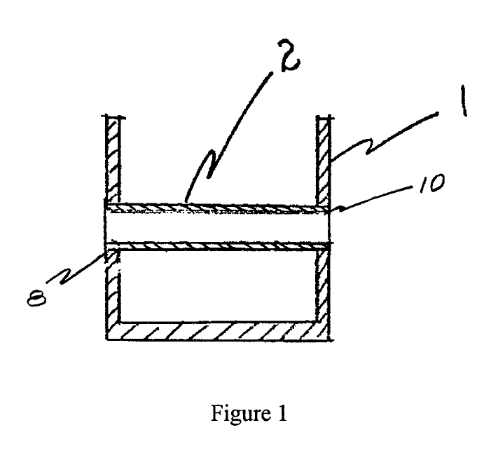

Figure Two is an isometric view of the device shown in FIG. 1 and showing the hold down slot.

Figure Three is an end on view of the instant device of FIG. 1 in place within the handle of the base tool.

Figure Four is a top view of the device of FIG. 1 in place within the handle of a base tool showing the hold down stud.

Figure Five is an end on view of a base tool handle showing the hold down stud.

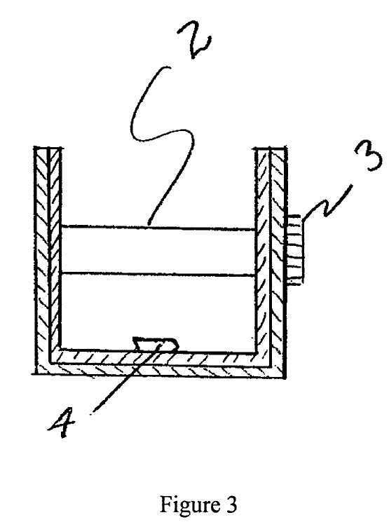

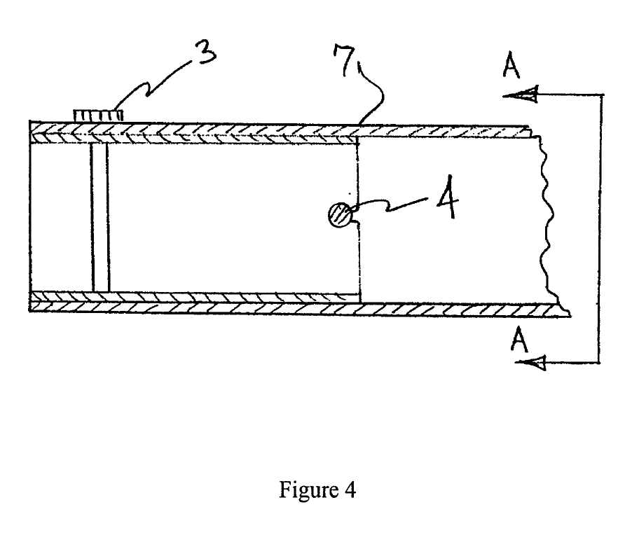

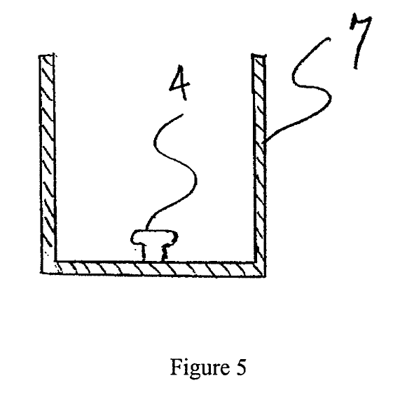

Figure Six is an alternate to the hold down stud of FIGS. 3 through 5 and illustrates the hold down tang.

Figure Seven illustrates the retaining bolt.

Figure Eight is a view of the prototype device showing the unshaped cartridge with ancillary knife-like tools in place.

Figure Nine is a view of the prior art Nabors et al. device. Note the slot and the latching mechanism.

### DESCRIPTION OF THE PREFERRED EMBODIMENT

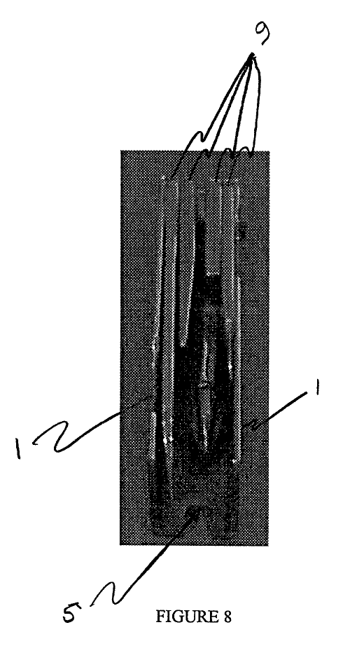

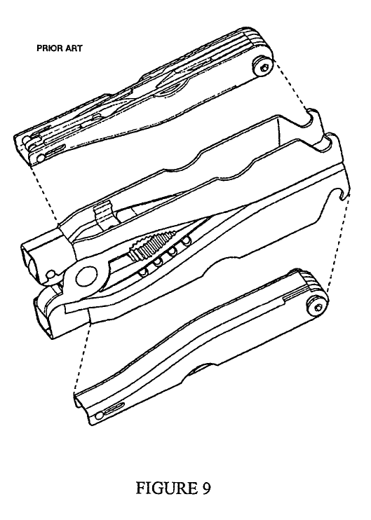

The preferred embodiment is shown in FIGS. 1 through 8. The instant invention, shown generally as 1, includes a set of knife-like tools, 9, and spring loads which are not illustrated for purposes of clarity. The instant device is formed from steel into a u-shape as shown in the Figures. The outside width of the channel (one side wall to the other) is set by the inside channel width of the handles of the base tool and should be chosen so that the instant device fits tightly within the handle of the base tool. The length of the ancillary tools and the requirements of the base tool set the length of the cartridge. As shown in FIG. 8, the overall length is the same as the longest knife blade; however, this is not necessarily the case. The length of the channel should be chosen to provide greatest stability for the cartridge when placed in the handle and could be longer or shorter than the longest ancillary tool.

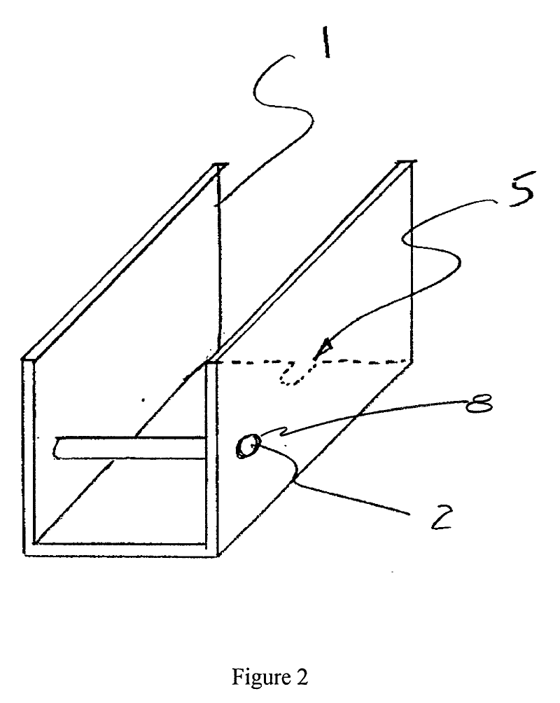

Springs (not shown) for spring loading the knife-like tools may be formed from the base of the cartridge channel or provided as a separate part attached to the cartridge. The knife-like ancillary tools pivot about the hollow pivot pin (or point), 2, which fits within a pin aperture, 8, formed within each sidewall. A notch, 5, see FIG. 2, may also be included in the cartridge base. The purpose of this notch will be explained.

The original base tool as manufactured by the manufacturer can be used with the instant device with little or no change to present manufacturing methods. The manufacturer need only leave out its ancillary knife-like tools during manufacturing. The manufacturer would still need to provide pivot apertures in the handles, as in the past. One aperture would be left plain, and the other aperture would be threaded or have a thread boss pressed into the aperture.

The manufacture would place its original ancillary tools within the cartridge, using standard manufacturing techniques. Instead of using a solid pivot pin, bar or point, the manufacturer would use a hollow pivot pin, 2, which is designed to accept the retaining bolt.

The complete cartridge, with a suitable selection of ancillary tools is placed inside the handle. The notch, 5, would fit under the stud, 4, to stop the expected rocking motion about the pivot point whenever a tool is selected or used. The cartridge is then held in place by the retaining bolt, 3, which passes through an aperture (similar to the pin aperture) in the base handle, through the hollow pivot pin and into the threads on the opposite side of the handle. (Alternately, threads (not shown) may be formed in the hollow pivot pin at location 10. The bolt would then have a matching set of threads, 12, formed near the head, 11, which would fit into the set within the hollow pivot. The retaining bolt is then tightened. The user would select the ancillary tool in the standard manner.

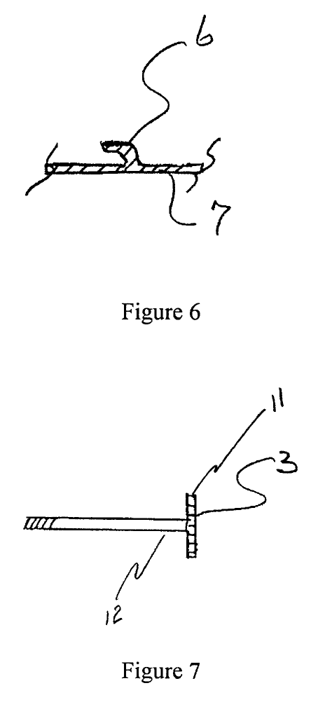

An alternate anti-rock method may be used instead of the stud, 4, and notch, 5. During manufacture of the base tool and as shown in FIG. 6, the manufacturer may press out a clip, 6, from the metal forming the bottom of the base tool handles. If this is the chosen method, then notch 5 may be omitted. In these circumstances the cartridge is placed into the base handle, with the end farthest from the hollow pivot passing under the clip. The clip will accomplish the same objective as the stud and notch. There are a number of techniques that may be used to inhibit the rocking motion, for example, clips or studs may be placed in the side walls of the base tool handles for interaction with the cartridge. Alternately, the cartridge could be designed to interact with the jaws of the tool and inhibit the expected rocking motion.

FIG. 9 shows the current state of the art (Nabors) that is sold under the brand name COLEMAN™. Comparison between the prior art of Nabors and the instant device clearly show that the Nabors device cannot readily be adapted to base tools manufactured by others.

The replaceable cartridge design can be readily adapted to most multifunction tools. Particularly to those made by LEATHERMAN™, KERSHAW™, SWOG™, and mired others that use simple u-shaped tool handles. The GERBER™ would require some modifications to the basic concept.

The GERBER multifunction tool uses a latching slot mechanism in the base of the tool handles, between the sidewalls of the handle. In this case, the instant device must be radically altered so that it would not interfere with the latching mechanism. The base u-channel of the instant device must be shortened, and this can be done independently of the cartridge walls or concurrently with the cartridge walls: it is simply a design choice. Because the GERBER tool's latching mechanism is located in the base of the handle, the anti-rocketing method must also be changed although it might be possible to use a clip or stud located in the base of the handle. It would be best to locate the anti-rocking tab, clip or tang in the sidewalls. The best technique would be to use extended cartridge sidewalls, with a slight angle to the ends. The slight angle would then slide under a clip formed in the side wall(s) of the base tool handle; thus, providing anti-rocking. These concepts and other concepts to provide anti-rocking to a replaceable ancillary tool cartridge for use in the GERBER tool would fall within the scope of this disclosure.

Another alternative design should be considered where the replaceable cartridge does NOT utilize the u-shaped channel. In this design the spring loading tangs could be left in the handles of the base tool. The replaceable ancillary tools would be mounted on a hollow pivot bar, without the u-shaped channel. The ancillary tool cartridge would then be held in place by the retaining pin or bolt, as described. Because the spring tangs are mounted in the base handles, there would be no tendency towards a rocking motion when the tools were employed. This alternative would limit the ancillary tool selection within the cartridge to a standard spacing as set by the fixed spring tangs within the handle; however, if no tangs were employed there would be no restriction.

It will be understood that the above description illustrates the preferred and best mode embodiment and reasonable alternative embodiments of the instant invention. The invention is not limited to the present forms illustrated, and the final form must be based on reasonable manufacturing decisions. For example, a number of methods or techniques have been described to avoid or inhibit the rocking motion that will occur whenever an ancillary tool is withdrawn or used. Another method for anti-rocking could involve a slight inward angle on the base tool handles which would interact with the cartridge to inhibit the rocking motion. In fact, a cheap version of a base tool could allow the rocking motion to exist. Thus, these and other modifications may be made in the design and arrangement of the elements while still falling within the scope of the disclosure.

I claim:

1. A replaceable tool cartridge adapted to retain a plurality of ancillary knife like tools capable of demountable insertion within a handle of a multifunction tool, comprising:
a hollow pivot pin about which the plurality of ancillary tools pivotally rotate; and
means to retain said hollow pivot pin within the handle of the multifunction tool.

2. The device of claim further comprising restraining means for keeping the plurality of ancillary tools on said hollow pivot pin.

3. The device of claim 2 wherein said restraining means comprises:
a u-shaped channel having two side walls and a base; and
a pivot aperture formed within each of said side walls for accepting said hollow pivot pin such that said side walls restrain the plurality of ancillary tools on said hollow pivot pin.

4. The device of claim 2 wherein said means to retain said hollow pivot pin within the handle of the multifunction tool comprises a retaining bolt.

5. The device of claim 4 wherein the handle of said multifunction tool acts to restrain the plurality of ancillary tools on said hollow pivot pin.

6. The device of claim 3 wherein said means to retain said hollow pivot pin within the handle of the multifunction tool comprises a retaining bolt.

7. The device of claim 6 further having anti-rocking means to prevent said unshaped channel from rocking about said hollow pivot pin whenever the ancillary tools are pivoted about said hollow pivot pin.

8. The device of claim 7 wherein the multifunction tool further has a stud contained within the handle thereof and wherein said anti-rocking means comprises:
a notch adapted to slide over the stud.

9. The device of claim 7 wherein the multifunction tool further has a clip formed within the handle thereof and wherein said anti-rocking means comprises:
sliding said base of said u-shaped channel over the clip.

10. A replaceable tool cartridge adapted to hold a plurality of ancillary knife-like tools capable of demountable insertion within a handle of a multifunction tool comprising:
a u-shaped channel having two side walls and a base;
a hollow pivot pin about which said plurality of ancillary tools may pivot;
a pivot aperture formed within each of said side walls for accepting said hollow pivot pin such that said hollow pivot pin lies between each side wall; and
a retaining bolt which passes through the handle of the multifunction tool and through said hollow pivot pin such that the replaceable tool is retained within the handle of the multifunction tool.

11. The device of claim 10 further having anti-rocking means to prevent said u-shaped channel from rocking about said hollow pivot pin whenever the ancillary tools are pivoted about said hollow pivot pin.

12. The device of claim 11 wherein the multifunction tool further has a stud contained within the handle thereof and wherein said anti-rocking means comprises:
a notch adapted to slide over the stud.

13. The device of claim 11 wherein the multifunction tool further has a clip formed within the handle thereof and wherein said anti-rocking means comprises:
sliding said base of said u-shaped channel over the clip.

14. The device of claim 11 wherein the multifunction tool further has a clip formed within the handle thereof and wherein said anti-rocking means comprises:
a notch adapted to slide over the clip.
